(19) United States
(12) Patent Application Publication
(10) Pub. No.: US 2015/0048932 A1
(43) Pub. Date: Feb. 19, 2015

(54) EMERGENCY RESPONSE SYSTEM AND METHOD

(71) Applicant: JULIANNA HELMS, CLOVER, SC (US)

(72) Inventor: JULIANNA HELMS, CLOVER, SC (US)

(21) Appl. No.: 13/968,782

(22) Filed: Aug. 16, 2013

(51) Int. Cl. G08B 27/00

(52) U.S. Cl. CPC G08B 27/005
USPC 340/286.02

(57) ABSTRACT

A method for communicating emergency information to a plurality of users within a facility is disclosed. In one aspect, the method includes receiving an emergency alert and status information from one of the plurality of users, and transmitting an emergency notification to the other of the plurality of users, including a request for status information. Status information is received from each of the plurality of users, and transmitted and displayed to an admin user. The status information received includes a status of the user and the area for which the user is responsible.

### COPYRIGHT STATEMENT

All of the material in this patent document is subject to copyright protection under the copyright laws of the United States and other countries. The copyright owner has no objection to the facsimile reproduction by anyone of the patent document or the patent disclosure, as it appears in official governmental records but, otherwise, all other copyright rights whatsoever are reserved.

### BACKGROUND OF THE INVENTION

The present invention relates to an emergency response system and, more particularly, to an artificial hand.

When a lockdown occurs, a code is given over the school intercom. Teachers will then lock their door, close the blinds, turn off the lights, and quietly huddle in the corner of the room. Next the teacher will grab the green, yellow, and red cards given to them for drills. Green means that the teacher has all her students. Yellow means that the teacher doesn't have all of her students, but she knows where they are. Red means that the teacher doesn't have all her students AND doesn't know where they are. The teacher will then write on the card that applies to them. For example: If I am missing students, but I know where they are. I would grab a yellow card and write the students names on the card and write where they are located. This card is then slid under the door into the hallway, and the principal and/or assistant principal walk around each wing to collect the cards. They must then flip through all the cards making sure students names match with the correct teacher, search the building for missing children, and try to avoid being a target to the intruder. The teacher is at a disadvantage because she has no way of notifying administration of hurt students or problems.

This procedure makes the teacher and her students “sitting ducks” because a card is directly outside of her classroom door, by letting the intruder know that students and a teacher are likely in the room.

Therefore, there exists a need for an improved emergency system and procedure.

### SUMMARY OF THE INVENTION

The present invention includes many aspects and features. Moreover, while many aspects and features relate to, and are described in, the context of an artificial hand for use by a person, the present invention is not limited to use only in such context, as will become apparent from the following summaries and detailed descriptions of aspects, features, and one or more embodiments of the present invention.

Accordingly, one aspect of the invention relates to a method includes receiving an emergency alert and status information from one of the plurality of users, and transmitting an emergency notification to the other of the plurality of users, including a request for status information. Status information is received from each of the plurality of users, and transmitted and displayed to an admin user. The status information received includes a status of the user and the area for which the user is responsible.

In a feature of this aspect, the method further comprises updating the status information from the at least one of the plurality of users.

In another feature of this aspect, the facility is a school building.

In another feature of this aspect, the user's area for which the user is responsible is a classroom, and the status of the user's area includes identifying any missing children from the classroom.

In another feature of this aspect, the status of the user's area further includes the known location of the identified missing children.

In another feature of this aspect, updating the status information includes receiving a location of the identified missing children once the identified child has been located by any one of the plurality of users.

In another feature of this aspect, the status indicator is one of a green indicator, yellow indicator, and red indicator.

In another feature of this aspect, the yellow indicator includes the identification of the missing children and their respective known locations.

In another feature of this aspect, the red indicator includes the identification of the missing children.

Another aspect of the invention relates to an emergency response system for communicating emergency information to a plurality of users within a facility. The system comprises a plurality of user workstations for transmitting status information to and from an emergency response server, and an emergency response server, for receiving status information from the plurality of user workstations and transmitting update status information to the plurality of workstations.

The emergency response server comprises a processor for executing a plurality of computer executable instructions, the plurality of computer executable instructions for implementing a method comprising the steps of transmitting an emergency notification to the plurality of users, including a request for status information, receiving the status information from at least one of the plurality of users, and transmitting a status indicator for each of the plurality of users to at least one Admin user, wherein the status information includes a status of the user's area in the facility for which the user is responsible.

In a feature of this aspect, the method further comprises updating the status information from the at least one of the plurality of users.

In another feature of this aspect, the facility is a school building, the user's area for which the user is responsible is a classroom, and the status of the user's area includes identifying any missing children from the classroom.

In another feature of this aspect, the status of the user's area further includes the known location of the identified missing children.

In another feature of this aspect, updating the status information includes receiving a location of the identified missing children once the identified child has been located by any one of the plurality of users.

In another feature of this aspect, the status indicator is one of a green indicator, yellow indicator, and red indicator.

In another feature of this aspect, the yellow indicator includes the identification of the missing children and their respective known locations, and the red indicator includes the identification of the missing children.

Another aspect of the invention relates to a computer implemented method for communicating emergency status information to an emergency response server comprising the steps of receiving an emergency indication and a request for area status information, selecting an appropriate area status information, and transmitting the selected are status information to the emergency response server.

In another feature of this aspect, the area status includes the status of a classroom and a status of each of a plurality of students in the classroom.

In another feature of this aspect, the status of each of the plurality of students includes the location of each of the plurality of students.

In another feature of this aspect, the method further comprises indicating that one or more of the plurality of students is not present in the classroom and a potential location of the one or more students not present in the classroom.

In addition to the aforementioned aspects and features of the present invention, it should be noted that the present invention further encompasses the various possible combinations and subcombinations of such aspects and features. Thus, for example, any aspect may be combined with an aforementioned feature in accordance with the present invention without requiring any other aspect or feature.

### BRIEF DESCRIPTION OF THE DRAWINGS

FIG. 1 is an example diagram of an emergency system in accordance with a disclosed implementation;

FIGS. 2-10 are example user interface screen in accordance with the disclosed emergency system;

FIGS. 11-12 are example user interface screens illustrating a building skeleton in accordance with the disclosed emergency system;

FIG. 13 is an example illustration of a user interface screen displaying a status message for missing children in accordance with the disclosed emergency system; and

FIG. 14 is an example flow diagram of the disclosed emergency system.

### DETAILED DESCRIPTION

With reference now to the drawings, it will be appreciated that one or more aspects and features of the invention are implemented in one or more preferred embodiments represented by the drawings.

As a preliminary matter, it will readily be understood by one having ordinary skill in the relevant art (“Ordinary Artisan”) that the present invention has broad utility and application. As should be understood, any embodiment may incorporate only one or a plurality of the above-disclosed aspects of the invention and may further incorporate only one or a plurality of the above-disclosed features. Furthermore, any embodiment discussed and identified as being “preferred” is considered to be part of a best mode contemplated for carrying out the present invention. Other embodiments also may be discussed for additional illustrative purposes in providing a full and enabling disclosure of the present invention. As should be understood, any embodiment may incorporate only one or a plurality of the above-disclosed aspects of the invention and may further incorporate only one or a plurality of the above-disclosed features. Moreover, many embodiments, such as adaptations, variations, modifications, and equivalent arrangements, will be implicitly disclosed by the embodiments described herein and fall within the scope of the present invention.

Accordingly, while the present invention is described herein in detail in relation to one or more embodiments, it is to be understood that this disclosure is illustrative and exemplary of the present invention, and is made merely for the purposes of providing a full and enabling disclosure of the present invention. The detailed disclosure herein of one or more embodiments is not intended, nor is to be construed, to limit the scope of patent protection afforded the present invention, which scope is to be defined by the claims and the equivalents thereof It is not intended that the scope of patent protection afforded the present invention be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection afforded the present invention is to be defined by the appended claims rather than the description set forth herein.

Additionally, it is important to note that each term used herein refers to that which the Ordinary Artisan would understand such term to mean based on the contextual use of such term herein. To the extent that the meaning of a term used herein—as understood by the Ordinary Artisan based on the contextual use of such term—differs in any way from any particular dictionary definition of such term, it is intended that the meaning of the term as understood by the Ordinary Artisan should prevail.

Regarding applicability of 35 U.S.C. §112, ¶6, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. Thus, reference to “a picnic basket having an apple” describes “a picnic basket having at least one apple” as well as “a picnic basket having apples.” In contrast, reference to “a picnic basket having a single apple” describes “a picnic basket having only one apple.”

When used herein to join a list of items, “or” denotes “at least one of the items,” but does not exclude a plurality of items of the list. Thus, reference to “a picnic basket having cheese or crackers” describes “a picnic basket having cheese without crackers”, “a picnic basket having crackers without cheese”, and “a picnic basket having both cheese and crackers.” Finally, when used herein to join a list of items, “and” denotes “all of the items of the list.” Thus, reference to “a picnic basket having cheese and crackers” describes “a picnic basket having cheese, wherein the picnic basket further has crackers,” as well as describes “a picnic basket having crackers, wherein the picnic basket further has cheese.”

Referring now to the drawings, one or more preferred embodiments of the present invention are next described. The following description of one or more preferred embodiments is merely exemplary in nature and is in no way intended to limit the invention, its implementations, or uses.

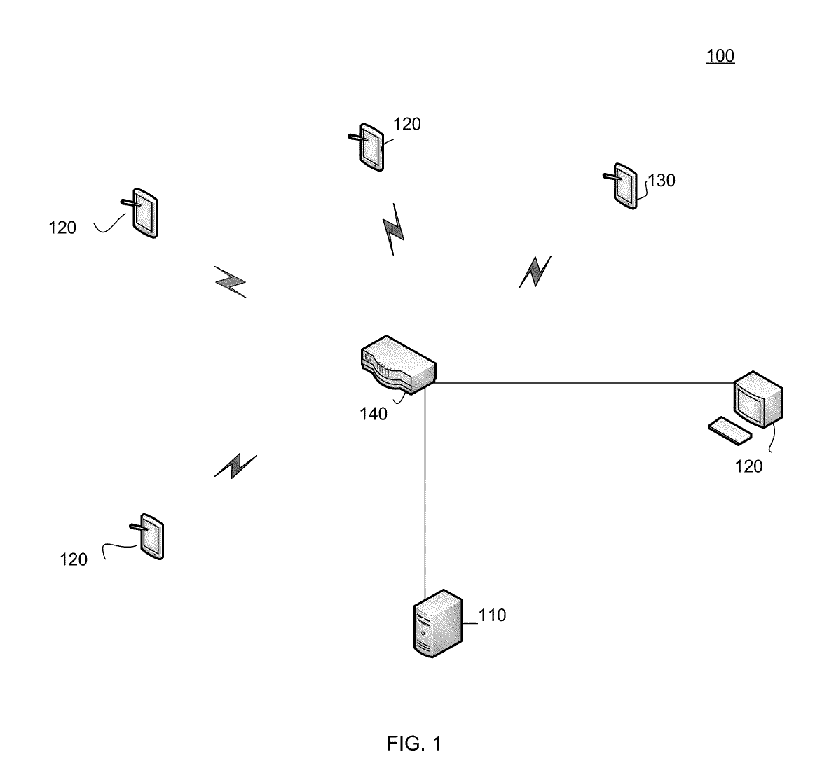

Turning now to FIG. 1, an aspect of a disclosed emergency response system 100 is illustrated. The disclosed emergency system 100 comprises an emergency server 110, and a plurality of distributed computing devices, workstations 120. The computing device 120 could be for example general purpose computers with a processing unit and graphical display unit. The computing device 120 could also be hand-held computers. The computing device 120 includes a memory storing an interactive, client-server based emergency response application that is executed by the processor in the workstation. The application provides user interface tools in the form of graphical screen displays which allow the user to enter and view emergency response information, to be disclosed below.

The network may include a router 140 providing a connection to an internet service provider (ISP) providing access to an external wide area internet protocol network such as the internet. A workstation 120 may be coupled to the enterprise network via the ISP whereby a user, e.g., a teacher, authorized to access the emergency response application may do so via the internet, ISP network access server and local area network. Thus a workstation 120, for accessing the emergency response procedure does not necessarily need to physically reside on the network or be physically located within or at the building.

Thus the emergency response system 100 that is installed in a public school allows the authorized users to communicate vital information to those users that need that information during an emergency. In accordance with a disclosed method, during an emergency school lock down, for example, the emergency response system allows teachers, administrators and first responders to communicate information relative to a lockdown condition. Example information may include student status, student location information, type of emergency, classroom status, etc.

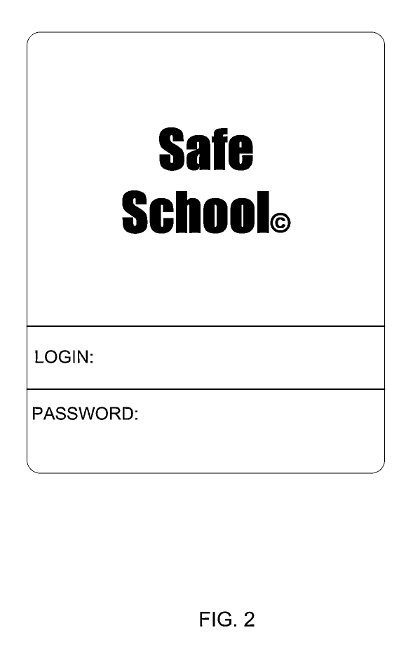

In a first aspect, a workstation 120 is disclosed for use with the emergency response server 110. The workstation comprises an application (software) comprising a set of machine readable code stored on a machine readable medium and executable on the computing device 120, 122, 130. The application provides a user interface for inputting and displaying emergency information transmitted to, and received from, the emergency server 110. The code in the application requests emergency information from a user of the workstation 120 and pulls emergency information from the emergency server 110 for inclusion into the display of the workstation 120. Example user interface screens for the application are illustrated in FIGS. 2-13.

The disclosed emergency server 110 comprises processor and an application (software) stored on a machine readable medium and executable on the server 110 by the processor. The emergency server 110 is preferably located at a remote location from the building, wherein communication with the emergency server is implemented through the network, i.e., internet ISP. This allows the emergency system to operate properly during an emergency event, even with the loss of power to the facility. The emergency server 110 acts as the central communication point for all of the authorized computing device 120.

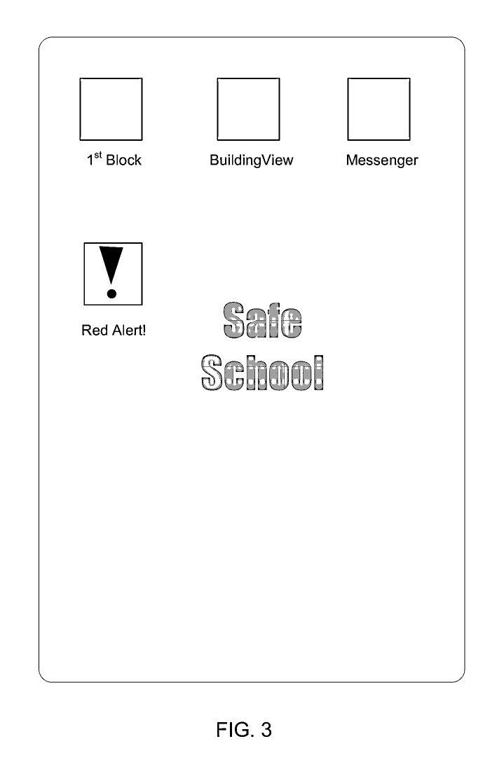

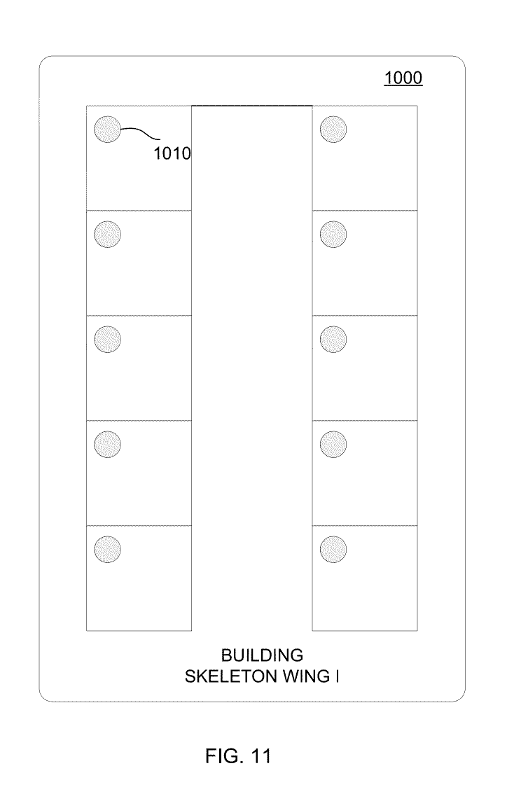

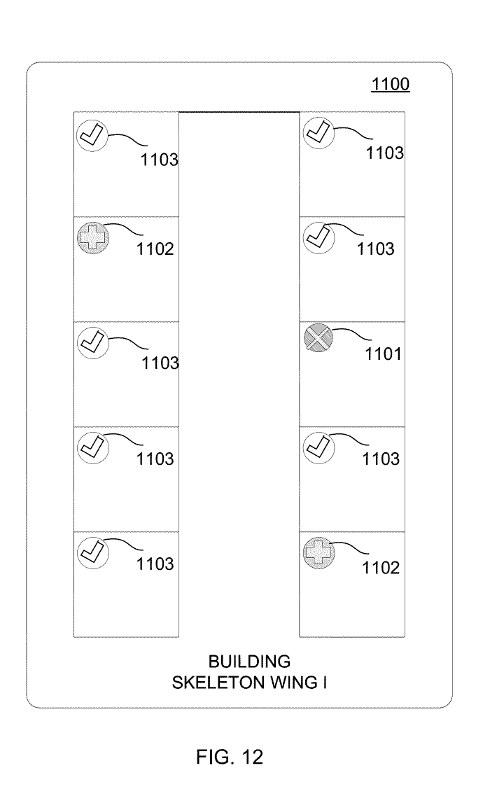

In an exemplary emergency system 100 implemented at a school, the emergency system comprises a plurality of teacher mobile computing device, e,g., tablets, at least one admin workstation, e.g., a mobile tablet, an emergency server located at a remote facility, and a first responder workstation. The first responder workstation comprises an application that allows communication with the emergency server, including an application user interface. The plurality of teacher workstations allow the teachers to provide important emergency information to the admin mobile tablet and the first responder workstation. The teacher mobile tablets include an application user interface. An example teacher application user interfaces are illustrated in FIGS. 2-10. As illustrated in these example screens, an authorized teacher is able log into the application, see FIG. 2, alert the emergency server of an emergency, and request and provide information to the server, using the application. FIG. 3, for example, is the home screen, wherein the user (i.e., a teacher) is able to select which user interface is displayed to the user. In this example, the user may select, 1^{st} Block, Building view, illustrated in FIGS. 11 and 12, Messenger and Red Alert screen, preferably Admin access only.

Referring back to FIG. 1, in accordance with a preferred implementation, the user (Admin or teacher) is able to communicate with the emergency server 110 the existence of an emergency by selecting the example Red Alert icon. Preferably, the Red Alert icon on the teacher user application only allows the teacher to communicate the existence of the emergency to the emergency server 110. Once the emergency server 110 receives a Red Alert from a teacher user workstation 120, the emergency server 110 alerts the Admin user workstation 130 of the emergency. The Admin user 130 must then determine whether the emergency alert should be forwarded to all users, and the type of emergency procedure to be followed.

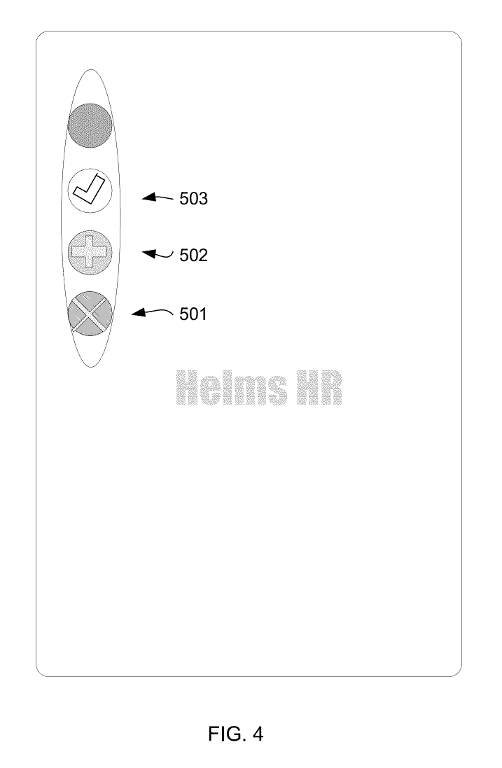

Once an emergency has been detected by the emergency server 110 and the Admin user 130 has issued a Red Alert, an emergency user interface screen is displayed for all admin and teacher mobile tablets. An example emergency user interface screen 500 is illustrated in FIG. 4. As illustrated, the emergency user interface screen 500 may include a plurality of status buttons 501-503 for selection by the user.

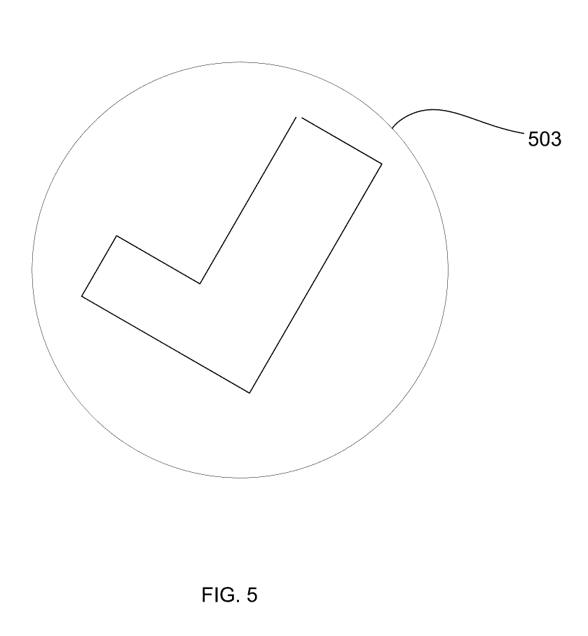

The status buttons 501-503 provide the emergency server, with the status of the user's classroom during the emergency. As illustrated, status button 503, illustrated in more detail in FIG. 5, when selected by the user, indicates, for example, that the user has all of his/her students and that they are all accounted for.

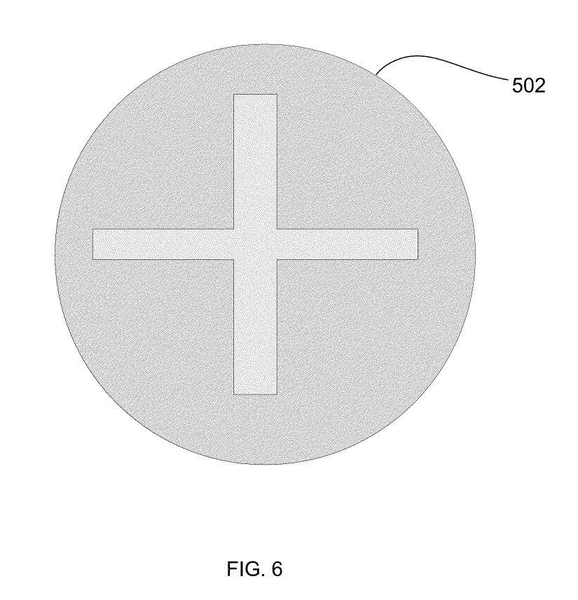

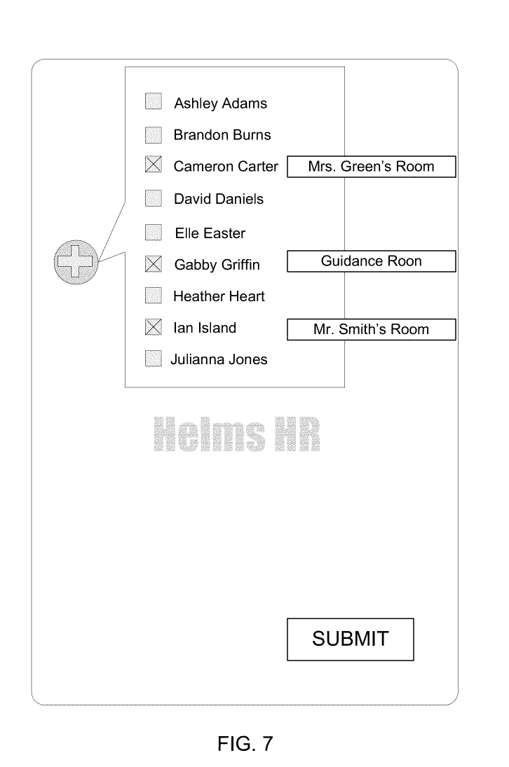

Status button 502, illustrated in FIG. 6, when selected by the user, indicates that the user does not have all of his/her students, but all of them are accounted for. When this status is sent to the emergency server, the user is requested to provide additional information. For example, an interface screen, exemplified in FIG. 7, is displayed requesting that the user indicate which student is not in the classroom and the student's location. The user then may select the student's name and enter his/her known location. This information is then forwarded to the emergency 110.

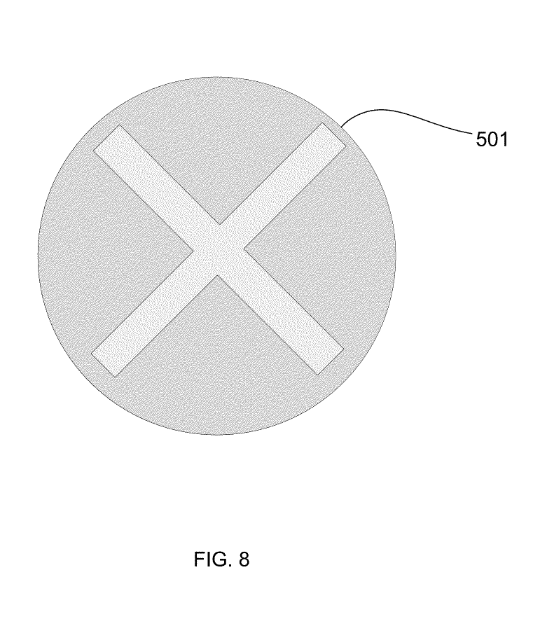

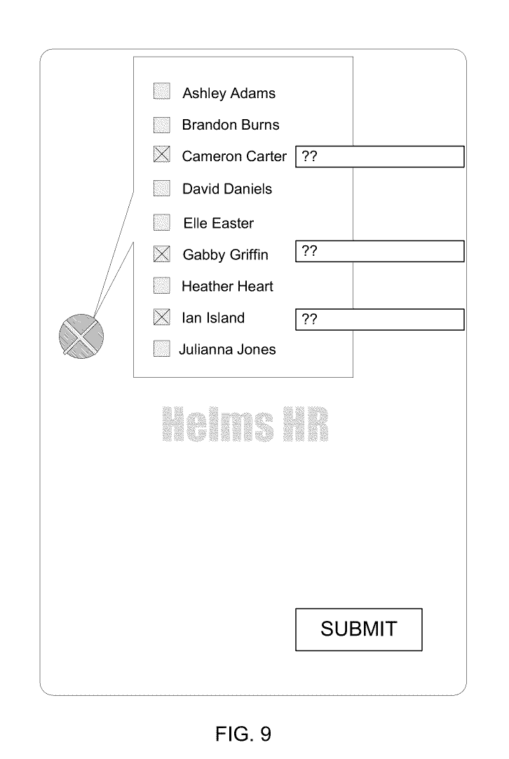

Status button 501, illustrated in FIG. 8, when selected by the user, indicates that the user does not have all of his/her students and cannot account for the missing student(s)'s location. When this status is selected by the user, the user is requested to provide additional information. A user interface screen, an example illustrated in FIG. 9, is displayed to the user requesting that the user identify the students that are missing and, if the user has an idea of the student's location, the possible location of the student.

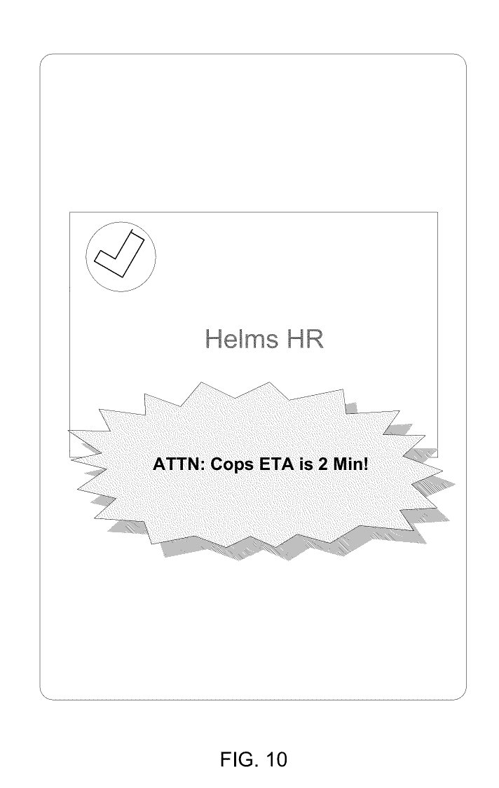

FIG. 10 is an example user interface screen that provides the user with status updates from the emergency server. For example, the Admin user may submit a message to the emergency server that the “Police ETA is 2 Min!” Upon receipt of the message by the server, the message is displayed to all emergency system users.

Although, the example illustrated in FIG. 10 is a message from the Admin user, the teacher users are able to message the Admin user in a similar manner. The message from the teacher is sent to the emergency server, then displayed to the Admin. For example the teacher user may inform the Admin that a student is bleeding, having a panic attack, etc. The message from the teacher is then forwarded and displayed to the Admin.

FIGS. 11 and 12 are example illustrations of a user interface screen 1000, 1100 respectively, for an Admin user. As illustrated, the user interface screen displays a building skeleton, for example Wing 1 of the building. Referring to FIG. 12, during a non-emergency, a status icon 1010 is displayed that indicates to the Admin user a non-emergency condition.

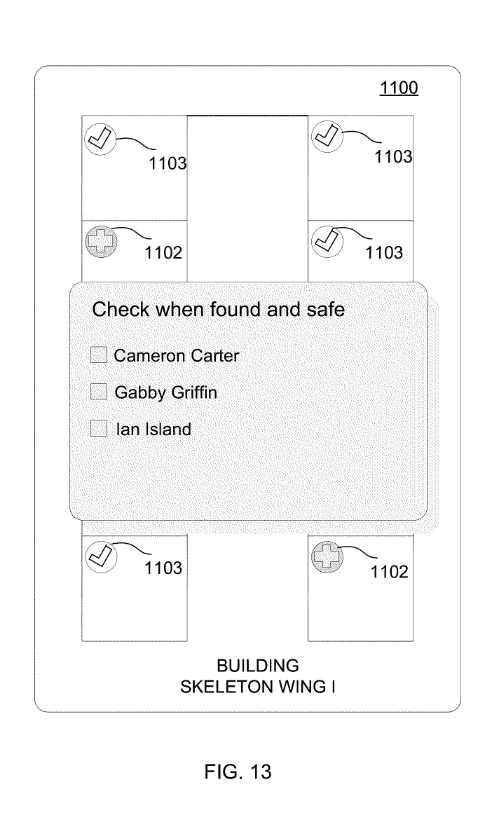

During an emergency, the Admin user interface screen, illustrated in FIG. 13, displays a similar building skeleton 1100, including status icons 1101-1103. The status icons 1101-1103 represent the status buttons selected by the teacher users and received by the emergency server. Accordingly, the status for each location in the facility that has an authorized user workstation is displayed in the location of the workstation. In the emergency school lockdown example, the admin workstation user is able to see the status of each classroom immediately, without the need to walk by each classroom. The admin user is also able to determine which students are missing and possible locations of each so that the administrator can quickly find the student and escort him/her to a safe location.

In an alternative implementation, the admin user interface may also provide the Admin the location in the facility where the alert was initiated.

FIG. 13 is an example illustration of a user interface screen that is displayed to an user once a teacher has provided the emergency server with his/her classroom status. As illustrated, all students that are missing throughout the building will be displayed to each user. If the student is safe and accounted for with a user, the user would select the students name indicating that the student is safe. This user interface screen is preferably constantly refreshed for each user, allowing only those students that are not safely accounted for by a user to be searched for by Admin, for example.

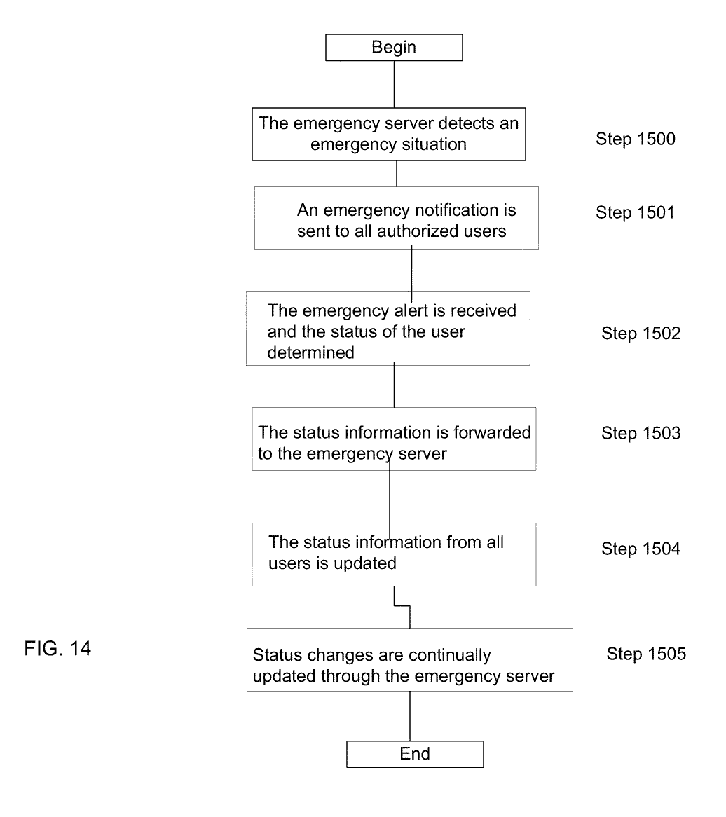

An example emergency procedure in accordance with the disclosed emergency system is illustrated in FIG. 14. The example procedure uses an emergency school lockdown procedure for exemplary purposes. When an authorized user of the disclosed emergency system, e.g., an Admin, detects an emergency situation, the Admin alerts the system of the emergency through the Admin's workstation, e.g., an iPad®. STEP 1500. Once the emergency alert is detected by the emergency server, an emergency notification is automatically sent to all authorized users by the emergency server, including the first responder workstation. Step 1501.

The teacher user would receive the Red Alert message and determine the status of his/her classroom, STEP 1502, and provide the requested information to the emergency server through the user interface, e.g., FIG. 4. STEP 1503. Preferably, the first responder workstation displays the type of emergency and the facility at which the emergency is/has occurred, allowing the first responders to react accordingly.

As the emergency server receives the requested information from each workstation, the server updates emergency status information for each workstation, and forwards updated admin information that is provided to each admin workstation. STEP 1504. The admin information preferably includes the status of each teacher workstation as it becomes available. See FIG. 13, for example. The building skeleton is continually updated as information is received by the emergency server. As students are located, the screen is updated and the status of the student changed. STEP 1505.

Based on the foregoing description, it will be readily understood by those persons skilled in the art that the present invention is susceptible of broad utility and application. Many embodiments and adaptations of the present invention other than those specifically described herein, as well as many variations, modifications, and equivalent arrangements, will be apparent from or reasonably suggested by the present invention and the foregoing descriptions thereof, without departing from the substance or scope of the present invention.

Accordingly, while the present invention has been described herein in detail in relation to one or more preferred embodiments, it is to be understood that this disclosure is only illustrative and exemplary of the present invention and is made merely for the purpose of providing a full and enabling disclosure of the invention. The foregoing disclosure is not intended to be construed to limit the present invention or otherwise exclude any such other embodiments, adaptations, variations, modifications or equivalent arrangements, the present invention being limited only by the claims appended hereto and the equivalents thereof.

What is claimed is:

1. A computer implemented method for communicating emergency information to a plurality of users within a facility, the method comprising:
transmitting an emergency notification to the plurality of users, including a request for status information;
receiving the status information from at least one of the plurality of users; and
transmitting a status indicator for each of the plurality of users to at least one Admin user;
wherein the status information includes a status of the user's area in the facility for which the user is responsible.

2. The computer implemented method of claim 1 further comprising updating the status information from the at least one of the plurality of users.

3. The computer implemented method of claim 2, wherein the facility is a school building.

4. The computer implemented method of claim 3, wherein the user's area for which the user is responsible is a classroom; and
wherein the status of the user's area includes identifying any missing children from the classroom.

5. The computer implemented method of claim 4, wherein the status of the user's area further includes the known location of the identified missing children.

6. The computer implemented method of claim 5, wherein updating the status information includes receiving a location of the identified missing children once the identified child has been located by any one of the plurality of users.

7. The computer implemented method of claim 5, wherein the status indicator is one of a green indicator, yellow indicator, and red indicator.

8. The computer implemented method of claim 7, wherein the yellow indicator includes the identification of the missing children and their respective known locations.

9. The computer implemented method of claim 8, wherein the red indicator includes the identification of the missing children.

10. An emergency response system for communicating emergency information to a plurality of users within a facility comprising:
a plurality of user workstations for transmitting status information to and from an emergency response server;
an emergency response server, for receiving status information from the plurality of user workstations and transmitting update status information to the plurality of workstations, the emergency response server comprising a processor for executing a plurality of computer executable instructions, the plurality of computer executable instructions for implementing a method comprising the steps of:
transmitting an emergency notification to the plurality of users, including a request for status information;
receiving the status information from at least one of the plurality of users; and
transmitting a status indicator for each of the plurality of users to at least one Admin user;
wherein the status information includes a status of the user's area in the facility for which the user is responsible.

11. The system of claim 10, wherein the method further comprises updating the status information from the at least one of the plurality of users.

12. The system of claim 11, wherein the facility is a school building;
wherein the user's area for which the user is responsible is a classroom; and
wherein the status of the user's area includes identifying any missing children from the classroom.

13. The system of claim 12, wherein the status of the user's area further includes the known location of the identified missing children.

14. The method of claim 13, wherein updating the status information includes receiving a location of the identified missing children once the identified child has been located by any one of the plurality of users.

15. The method of claim 13, wherein the status indicator is one of a green indicator, yellow indicator, and red indicator.

16. The method of claim 7, wherein the yellow indicator includes the identification of the missing children and their respective known locations; and wherein the red indicator includes the identification of the missing children.

17. A computer implemented method for communicating emergency status information to an emergency response server comprising the steps of:
receiving an emergency indication and a request for area status information;
selecting an appropriate area status information; and
transmitting the selected are status information to the emergency response server.

18. The computer implemented method of claim 17, wherein the area status includes the status of a classroom and a status of each of a plurality of students in the classroom.

19. The computer implemented method of claim 18, wherein the status of each of the plurality of students includes the location of each of the plurality of students.

20. The computer implemented method of claim 19 further comprising indicating that one or more of the plurality of students is not present in the classroom and a potential location of the one or more students not present in the classroom.
